(19) United States
(12) Patent Application Publication
(10) Pub. No.: US 2022/0325767 A1
(43) Pub. Date: Oct. 13, 2022

(54) FRICTION MATERIAL

(71) Applicant: BorgWarner Inc., Auburn Hills, MI (US)

(72) Inventors: Feng Dong, Rochester, MI (US); Wanjun Liu, Troy, MI (US); Kazuyuki Toyama, West Bloomfield, MI (US)

(21) Appl. No.: 17/227,677

(22) Filed: Apr. 12, 2021

(51) Int. Cl. F16D 69/02; F16D 25/0635

(52) U.S. Cl. CPC F16D 69/026; F16D 69/023; F16D 25/0635; F16D 2200/0052; F16D 2200/0065; F16D 2200/0069

(57) ABSTRACT

A friction material presents a friction-generating surface and a bonding surface opposite the friction-generating surface. The friction material includes unbranched fiber having a diameter of from 0.5 to 50 μm and a length of from 0.2 to 15 mm, branched fiber having a diameter of from 1 to 50 μm, and a resin disposed throughout the friction material. The friction material is substantially free of particles and defines a plurality of pores having a pore size distribution with a D10 value of from 5 to 15 μm, a D50 value of from 15 to 30 μm, and a D90 value of from 30 to 60 μm.

### FIELD OF THE DISCLOSURE

This disclosure generally relates to a friction material that may be used in a variety of different applications including in a friction plate in a clutch assembly in a transmission.

### BACKGROUND

Several components of a powertrain of a motor vehicle may employ a wet clutch to facilitate the transfer of power from the vehicle's power generator (e.g. an internal combustion engine, electric motor, fuel cell, etc.) to drive wheels of the motor vehicle. A transmission located downstream from the power generator that enables vehicle launch, gear shifting, and other torque transfer events is one such component. Some form of a wet clutch is commonly found throughout many different types of transmissions currently available for motor vehicle operation.

A wet clutch is an assembly that interlocks two or more opposed, rotating surfaces in the presence of a lubricant by imposing selective interfacial frictional engagement between those surfaces. At the point of engagement, a friction material is utilized to generate the interfacial frictional engagement. The friction material is supported by a friction clutch plate, a band, a synchronizer ring, or some other part. The presence of the lubricant at the friction interface cools and reduces wear of the friction material and permits some initial slip to occur so that torque transfer proceeds smoothly and quickly, in an effort to avoid the discomfort that may accompany an abrupt torque transfer event (i.e., shift shock).

Friction materials used in the variety of wet clutches found in motor vehicle powertrains must be able to withstand repeated forces and elevated temperatures that are typically generated during the repeated engagement and disengagement of transmissions. During use, the friction material must be able to maintain a relatively constant friction throughout engagement, i.e., frictional engagement while reducing temperature build up, and maintaining structural and cohesive integrity to ensure consistent performance for thousands of engagements and disengagements of such transmissions.

In view of the above, there remains an opportunity to develop a friction material with improved performance properties in a wide variety of different wet clutch applications.

### SUMMARY OF THE DISCLOSURE

In one embodiment, a friction material presents a friction-generating surface and a bonding surface opposite the friction-generating surface. The friction material includes unbranched fiber having a diameter of from 0.5 to 50 μm and a length of from 0.2 to 15 mm, branched fiber having a diameter of from 1 to 50 μm, and a resin disposed throughout the friction material. The friction material is substantially free of particles and defines a plurality of pores having a pore size distribution with a D10 value of from 5 to 15 μm, a D50 value of from 15 to 30 μm, and a D90 value of from 30 to 60 μm.

In another embodiment, a friction material defines a plurality of pores and presents a friction-generating surface and a bonding surface opposite the friction-generating surface. The friction material includes unbranched fiber having a diameter of from 0.5 to 50 μm and a length of from 0.2 to 15 mm, branched fiber having a diameter of from 1 to 50 μm, and a resin disposed throughout the friction material. The unbranched fiber and the branched fiber are present in the friction material in volume ratio of from 1:5 to 1:1, and are collectively present in the friction material in an amount greater than 90 weight percent, based on a total weight of all non-resin components in the friction material.

Advantageously, the friction material generates friction and withstands repeated forces and elevated temperatures that are typically generated during the repeated engagement and disengagement of transmissions despite the friction material being substantially free of particles. The combination of branched and unbranched fibers impart strength to the friction material thus eliminating the need for particles, which provides for larger, more consistent pores. As such, the friction material may be used in a wide variety of wet clutch applications and performs optimally across this wide variety of wet clutch applications.

### BRIEF DESCRIPTION OF THE FIGURES

Other advantages of the present disclosure will be readily appreciated, as the same becomes better understood by reference to the following detailed description when considered in connection with the accompanying drawings. The individual components in one or more of the drawings may not be shown to scale.

FIG. 1 is an enlarged cross-sectional view of one embodiment of a friction material including unbranched fiber, branched fiber, and a resin.

FIG. 2A is an enlarged, isolated view of an example unbranched fiber.

FIG. 2B is a photograph of an enlarged, isolated example unbranched fiber.

FIG. 3A is an enlarged, isolated view of an example branched fiber.

FIG. 3B is a photograph of an enlarged, isolated example branched fiber.

FIG. 4 is a cross-sectional view of a friction plate including the friction material of FIG. 1.

FIG. 5 is an enlarged cross-sectional view of an embodiment of a friction material including unbranched fiber, branched fiber, and a resin having a deposit thereon.

FIG. 6 is a cross-sectional view of a friction plate including the friction material of FIG. 3.

FIG. 7 is a perspective view of a clutch assembly including a plurality of friction and separator plates in a transmission.

FIG. 8 is a graphical analysis of the pore size and pore size distribution of Example 5 and Comparative Example 1.

FIG. 9 is a graphical analysis of the dynamic COF of Example 7 and Comparative Example 1.

FIG. 10 is a graphical analysis of the shear strength of Example 7 and Comparative Example 1.

FIG. 11 is a graphical analysis of the compression of Example 7 and Comparative Example 1.

FIG. 12 is a graphical analysis of the “Hot Spot Level” friction performance of the friction materials of Examples 5-8, which include different resin loadings.

It should be appreciated that the drawings are illustrative in nature and are not necessarily drawn to scale.

### DETAILED DESCRIPTION OF THE DISCLOSURE

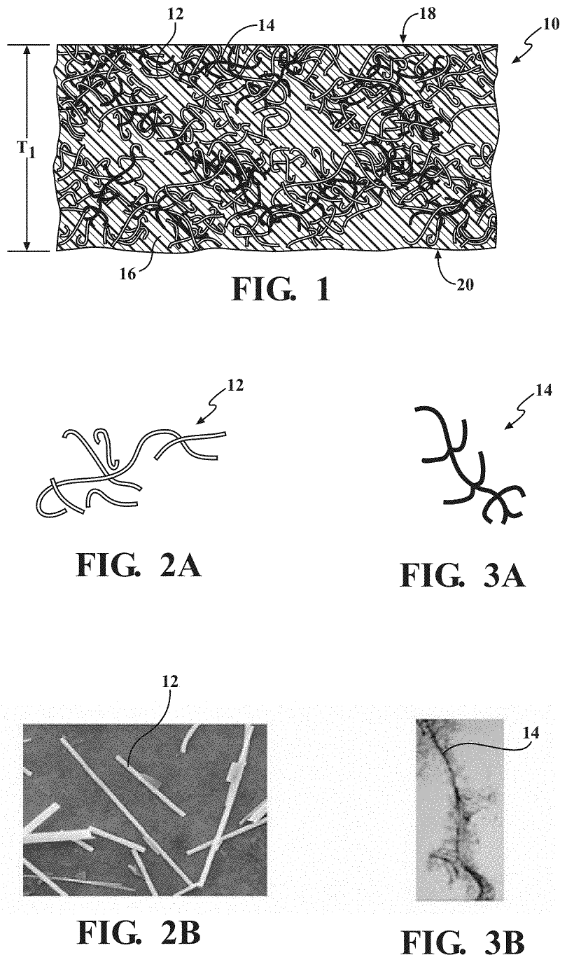

Referring to the Figures, wherein like numerals indicate corresponding parts throughout the several views, a friction material is shown generally at 10. The friction material 10 defines a plurality of pores, and presents a friction-generating surface 18 and a bonding surface 20 facing opposite the friction-generating surface 18. Referring now to FIG. 1, the friction material 10 includes unbranched fiber 12 and branched fiber 14, and a resin 16, which are described in turn below.

It should be appreciated that include, includes, and including are the same as comprise, comprises, and comprising when used throughout this disclosure.

As is illustrated in the cross-sectional view of FIG. 1, the friction material 10 includes unbranched fiber 12. The unbranched fiber 12 may also be referred to as floc fiber. FIG. 2A is a drawing representing an enlarged, isolated view of an example unbranched fiber 12, and FIG. 2B is a photograph of an enlarged, isolated example unbranched fiber 12.

The unbranched fiber 12 may be alternatively described as a plurality of fibers or unbranched fibers. The unbranched fiber 12 may include one or more different types of fibers. Accordingly, the unbranched fiber 12 may be chosen from acrylic fibers, aramid fibers, carbon fibers, cellulose fibers, glass fibers, mineral fibers, phenolic fibers, polyvinyl alcohol fibers, and combinations thereof. In various embodiments, the unbranched fiber 12 includes one of, or a combination of the aforementioned unbranched fiber types. All weight ranges and ratios of the various combinations of the aforementioned unbranched fiber types are hereby expressly contemplated in various non-limiting embodiments.

In various embodiments, the unbranched fiber 12 includes aramid. In other embodiments, the unbranched fiber 12 consists of or consists essentially of aramid. One or more types of aramids may be used. In one embodiment, the aramid is poly-paraphenylene terephthalamide. In another embodiment, the aramid is two or more types of aramids, e.g. a first poly-paraphenylene terephthalamide and a second poly-paraphenylene terephthalamide that is different from the first. Various non-limiting examples of aramids include tradenames such as KEVLAR®, NEW STAR®, NOMEX®, TEIJINCONEX®, and TWARON®. Of course, in other embodiments, aramid fibers of other tradenames may be used.

In some embodiments, the unbranched fiber 12 includes carbon. In other embodiments, the unbranched fiber 12 consists essentially of or consists of carbon. Of course, in various embodiments, the unbranched fiber 12 can include aramid fibers and/or carbon fibers.

In still other embodiments, the unbranched fiber 12 includes acrylic. Acrylic is formed from one or more synthetic acrylic polymers such as those formed from at least 85% by weight acrylonitrile monomers. In other embodiments, the unbranched fiber 12 consists essentially of or consists of acrylic.

The unbranched fiber 12 has a diameter of from 0.5 to 50 μm and a length of from 0.2 to 15 mm. In various embodiments, the unbranched fiber 12 has an average diameter of from 0.5 to 50, from 1 to 25, or from 2 to 20, μm, and average lengths of from 0.2 to 15 mm, from 0.5 to 10, from 1 to 9, from 1 to 8, from 1 to 7, from 2 to 9, or from 2 to 6, mm. In additional non-limiting embodiments, all values and ranges of diameter and length within and including the aforementioned range endpoints are hereby expressly contemplated.

In many embodiments, the unbranched fiber 12 is present in an amount of from 10 to 75, from 15 to 50, from 25 to 40, from 28 to 37, or from 30 to 35, % by volume based on a total volume of fiber in the friction material 10. In additional non-limiting embodiments, all values and ranges of values of unbranched fiber 12 amounts within and including the aforementioned range endpoints are hereby expressly contemplated.

As is also illustrated in the cross-sectional view of FIG. 1, the friction material 10 also includes branched fiber 14. The branched fiber 14 may also be referred to as pulp fiber.

The branched fiber 14 may be alternatively described as a plurality of branched fiber(s) or branched fibers. The branched fiber 14 may include one or more different types of fibers. Accordingly, the branched fiber 14 may be chosen from acrylic fibers, aramid fibers, cellulose fibers, and combinations thereof. In various embodiments, the branched fiber 14 includes one of, or a combination of the aforementioned unbranched fiber types. All weight ranges and ratios of the various combinations of the aforementioned branched fiber types are hereby expressly contemplated in various non-limiting embodiments.

In some embodiments, the branched fiber 14 includes acrylic. Acrylic is formed from one or more synthetic acrylic polymers such as those formed from at least 85% by weight acrylonitrile monomers. In other embodiments, the branched fiber 14 consists essentially of or consists of acrylic.

In many embodiments, the branched fiber 14 includes aramid. In other embodiments, the branched fiber 14 consists of or consists essentially of aramid. One or more types of aramids may be used. In one embodiment, the aramid is poly-paraphenylene terephthalamide. In another embodiment, the aramid is two or more types of aramids, e.g. a first poly-paraphenylene terephthalamide and a second poly-paraphenylene terephthalamide that is different from the first. In various preferred embodiments, aramid fibers of the tradename KEVLAR® or TWARON® may be used. Of course, in other embodiments, aramid fibers of other tradenames may be used.

In some embodiments, the branched fiber 14 includes cellulose, e.g. from wood, cotton, etc. In other embodiments, the branched fiber 14 consists essentially of or consists of cellulose. The cellulose fibers may be chosen from abacá fiber, bagasse fiber, bamboo fiber, coir fiber, cotton fiber, fique fiber, flax fiber, linen fiber, hemp fiber, jute fiber, kapok fiber, kenaf fiber, piña fiber, pine fiber, raffia fiber, ramie fiber, rattan fiber, sisal fiber, wood fiber, and combinations thereof. In some specific embodiments, cellulose fibers that are derived from wood are used, such as birch fibers and/or eucalyptus fibers. In other embodiments, cellulose fibers such as cotton fibers are used. Of course, in various embodiments the branched fiber 14 can include aramid fibers and/or cellulose fibers.

The branched fiber 14 has a diameter of from 1 to 50 μm. Accordingly, in various embodiments, the branched fiber 14 has an average diameter of from 0.5, or from 2 to 20, μm. In additional non-limiting embodiments, all values and ranges of diameter within and including the aforementioned range endpoints are hereby expressly contemplated.

In various embodiments, the branched fiber 14 has a Canadian Standard Freeness (CSF) degree of fibrillation of from 10 to 700. In many embodiments, branched fiber 14 has a Canadian Standard Freeness (CSF) degree of fibrillation of less than 700, 600, 500, 400, 300, 200, or 100, but greater than 10 or 20. In additional non-limiting embodiments, all values and ranges of values of CSF within and including the aforementioned range endpoints are hereby expressly contemplated.

The terminology “Canadian Standard Freeness” (T227 om-85) describes that the degree of fibrillation of fibers may be described as the measurement of freeness of the fibers. The CSF test is an empirical procedure which gives an arbitrary measure of the rate at which a suspension of three grams of fiber in one liter of water may be drained. Therefore, less fibrillated fibers have higher freeness or higher rate of drainage of fluid from the friction material 10 than other fibers or pulp. Notably, CSF values can be converted to Schopper Riegler values. The CSF can be an average value representing the CSF of all branched fiber 14 in the friction material 10. As such, it is to be appreciated that the CSF of any one particular type of branched fiber 14 may fall outside the ranges provided above, yet the average value will fall within these ranges.

In many embodiments, the branched fiber 14 is present in an amount of from 25 to 90, from 50 to 85, from 60 to 75, from 62 to 77, or from 65 to 75, % by volume based on a total volume of fiber in the friction material 10. In additional non-limiting embodiments, all values and ranges of values of branched fiber 14 amounts within and including the aforementioned range endpoints are hereby expressly contemplated.

In some embodiments, the friction material 10 includes the unbranched fiber 12 and the branched fiber 14 in volume ratio of from 1:5 to 1:1, from 1:3 to 1:1, from 1:3 to 2:3, or from 3:7 to 7:13. Further, in many embodiments, the unbranched fiber 12 and the branched fiber 14 are collectively present in the friction material 10 in an amount greater than 90, 91, 92, 93, 94, 95, 96, 97, or 98, volume percent, based on a total volume of all non-resin components in the friction material 10. The remaining 10, 9, 8, 7, 6, 5, 4, 3, or 2, volume percent is typically various non-particulate paper making additives. Alternatively, in many embodiments, the unbranched fiber 12 and the branched fiber 14 are collectively present in the friction material 10 in an amount greater than 90, 91, 92, 93, 94, 95, 96, 97, or 98, weight percent, based on a total weight of all non-resin components in the friction material 10. The remaining 10, 9, 8, 7, 6, 5, 4, 3, or 2, weight percent is typically non-particulate paper making additives.

For example, in one embodiment, the friction material 10 includes the unbranched fiber 12 having a diameter of from 0.5 to 50 μm and a length of from 0.2 to 15 mm, the branched fiber 14 having a diameter of from 1 to 50 μm, and the resin 16. In this example, the unbranched fiber 12 and the branched fiber 14 are present in the friction material 10 in volume ratio of from 1:5 to 1:1 (or even 1:3 to 1:1), and are collectively present in the friction material 10 in an amount greater than 90 weight percent, based on a total weight of all non-resin components in the friction material 10. In this example remaining weight percent (e.g. the remaining 10 weight percent or less) comprises various non-particulate paper making additives.

In some embodiments, the non-resin components included in the friction material 10 consist essentially of or consist of the unbranched fiber 12 and the branched fiber 14. It should be appreciated that the terminology “consists essentially of” as used throughout this disclosure describes embodiments that include a designated component(s) (e.g. the unbranched fiber 12 and the branched fiber 14) in an amount of greater than 90, 91, 92, 93, 94, 95, 96, 97, 98, 99, 99.5, 99.9, 99.95, or 99.99, percent by weight, and less than 10, 9, 8, 7, 6, 5, 4, 3, 2, 1, 0.5, 0.1, 0.05, or 0.01 percent by weight, based on a total weight of all components included (e.g. a total weight of the non-resin components in the friction material 10).

As is also illustrated in the cross-sectional view of FIG. 1, the friction material 10 also includes resin 16. In various embodiments, the resin 16 is dispersed homogeneously or heterogeneously throughout the friction material 10. The resin 16 may be any known in the art and may be curable. Alternatively, the resin 16 may be of the type that does not cure. In various embodiments, depending on the stage of formation of the friction material 10, the resin 16 may be uncured, partially cured, or entirely cured.

The resin 16 may be any thermosetting resin suitable for providing structural strength to the friction material 10. Various resins 16 that may be utilized include phenolic resins and phenolic-based resins. A phenolic resin is a class of thermosetting resins that is produced by the condensation of an aromatic alcohol, typically a phenol, and an aldehyde, typically a formaldehyde. A phenolic-based resin is a thermosetting resin blend that typically includes at least 50 wt. % of a phenolic resin based on the total weight of all resins and excluding any solvents or processing acids. It is to be understood that various phenolic-based resins may include modifying ingredients, such as epoxy, butadiene, silicone, tung oil, benzene, cashew nut oil and the like. In some embodiments, a silicone modified phenolic resin which includes 5 to 80 weight percent of a silicone resin with the remainder weight percent being attributed to a phenolic resin or combination of phenolic and other different resins is used. In other embodiments, an epoxy modified phenolic resin which includes 5 to 80 weight percent of an epoxy resin with the remainder weight percent being attributed to a phenolic resin or combination of phenolic and other different resins is used.

In some embodiments, the resin 16 includes a silicone resin, for example, 5 to 100 or 5 to 80, weight percent of the silicone resin based on the total weight of all resins and excluding any solvents or processing acids. Silicone resins that may be used may include thermal curing silicone sealants and silicone rubbers. Various silicone resins may also be used such as those that include D, T, M, and Q units (e.g. DT resins, MQ resins, MDT resins, MTQ resins, QDT resins, etc.).

In various embodiments, the resin 16 is present in an amount of from 45 to 120, from 45 to 100, from 45 to 80, from 50 to 75, or from 50 to 60, weight percent based on a total weight of all non-resin components in the friction material 10. This value may be alternatively described as resin “pick up.” In additional non-limiting embodiments, all values and ranges of values of resin amounts within and including the aforementioned range endpoints are hereby expressly contemplated.

Once cured, the cured resin 17 confers strength and rigidity to the friction material 10 and adheres the components to one another while maintaining a desired porosity for proper lubricant flow and retention, and also bonds the friction material 10 to the substrate 32, as described below.

The friction material 10 may be substantially free of particles, or even completely free of particles. For purposes of the subject disclosure, particles are generally spherical portions of matter (e.g. round particles, platelets, etc.). Non-limiting examples of particles the friction material 10 may be substantially free of, or even completely free of include: diatomaceous earth particles, silica particles, carbon particles, graphite particles, alumina particles, magnesia particles, calcium oxide particles, titania particles, ceria particles, zirconia particles, cordierite particles, mullite particles, sillimanite particles, spodumene particles, petalite particles, zircon particles, silicon carbide particles, titanium carbide particles, boron carbide particles, hafnium carbide particles, silicon nitride particles, titanium nitride particles, titanium boride particles, cashew nut particles, and rubber particles. Particles can sometimes be referred to as filler. It should be appreciated that the terminology “substantially free” as used throughout this disclosure describes embodiments that include a designated component(s) (e.g. particles) in an amount of less than 7, 6, 5, 4, 3, 2, 1, 0.5, 0.1, 0.05, or 0.01 percent by weight, based on a total weight of all components included in the friction material (e.g. based on a total weight of the friction material 10).

The friction material 10 may further include additives known in the art.

The initial thickness T₁ of the friction material 10, is typically from 0.3 to 4, from 0.4 to 3, from 0.4 to 2, from 0.4 to 1.6, from 0.4 to 1.5, from 0.5 to 1.4, from 0.6 to 1.3, from 0.7 to 1.2, from 0.8 to 1.1, or from 0.9 to 1, mm. This thickness T₁ refers to a thickness prior to bonding to the substrate 32 and may be referred to as caliper thickness. This thickness T₁ can refer to the thickness of the friction material 10 with uncured resin 16 present, or the thickness of the raw paper without resin 16. In additional non-limiting embodiments, all values and ranges of values of thickness T₁ within and including the aforementioned range endpoints are hereby expressly contemplated.

After bonding to a substrate 32 and resin cure, a total thickness T₂ of the friction material 10 is typically from 0.3 to 3.75, from 0.4 to 3, from 0.4 to 2, from 0.4 to 1.6, from 0.4 to 1.5, from 0.5 to 1.4, from 0.6 to 1.3, from 0.7 to 1.2, from 0.8 to 1.1, or from 0.9 to 1, mm. This thickness T₂ is typically measured after bonding to the substrate 32. In additional non-limiting embodiments, all values and ranges of values of total thickness T₂ within and including the aforementioned range endpoints are hereby expressly contemplated.

The friction material 10 includes a plurality of pores (sometimes referred to simply as pores). Each of the pores has a pore size. The pores are typically dispersed throughout the friction material 10. Pore size may be determined using American Society for Testing and Materials (“ASTM”) test method D4404-10.

The plurality of pores may have a particle size distribution having: a D10 value of from 5 to 15, from 7 to 15, from 7 to 13, or from 9 to 15, μm; a D50 value of from 15 to 30, or from 15 to 23, μm; and a D90 value of from 30 to 60, or from 34 to 46, μm. D50 describes the median diameter of the pores in a distribution of the pores (within the plurality of pores). For example, in any given sample of the friction material 10, 50% of the pores have a diameter which is smaller than D50 and the other 50% of the pores have a diameter which is larger than D50. D10 describes the diameter of the smallest 10% of pores in a distribution of the pores. For example, in any given sample of the friction material 10, 10% of the pores have a diameter which is smaller than D10 and 90% of the pores have a diameter which is greater than D10. D90 describes the diameter of the largest 10% of pores in a distribution of pores. For example, in any given sample of the friction material 10, 90% of the pores have a diameter which is smaller than D90 and 10% of the pores have a diameter which is greater than D90.

For example, in one embodiment, the friction material 10 includes the unbranched fiber 12 having a diameter of from 0.5 to 50 μm and a length of from 0.2 to 15 mm, the branched fiber 14 having a diameter of from 1 to 50 μm, and the resin 16. In this example, the friction material 10 is substantially free of particles and defines a plurality of pores having a pore size distribution with a D10 value of from 5 to 15 μm, a D50 value of from 15 to 30 μm, and a D90 value of from 30 to 60 μm.

In other embodiments, the friction material 10 has a porosity of from 50 to 85, from 55 to 80, or from 60 to 70, % as determined using ASTM test method D4404-10. The porosity of the friction material 10 may be described as a percentage of the friction material 10 that is open to air. Alternatively, the porosity may be described as the percentage of the friction material 10, based on volume, that is air or not solid. In additional non-limiting embodiments, all values and ranges of values of porosity within and including the aforementioned range endpoints are hereby expressly contemplated.

The more porous the friction material 10, the more efficiently heat is dissipated. The oil flow in and out of the friction material 10 during engagement of the friction material 10 during use occurs more rapidly when the friction material 10 is porous. For example, when the friction material 10 has a higher mean flow pore diameter and porosity, the friction material 10 is more likely to run cooler or with less heat generated in a transmission due to better automatic transmission fluid flow throughout the pores of the friction material 10. During operation of a transmission, oil deposits on the friction material 10 tend to develop over time due to a breakdown of automatic transmission fluid, especially at high temperatures. The oil deposits tend to decrease the size of the pores. Therefore, when the friction material 10 is formed with larger pores, the greater the remaining/resultant pore size after oil deposit.

In various embodiments, the friction material 10 has high porosity such that there is a high fluid permeation capacity during use. In such embodiments, it may be important that the friction material 10 not only be porous, but also be compressible. For example, the fluids permeated into the friction material 10 typically must be capable of being squeezed or released from the friction material 10 quickly under the pressures applied during operation of the transmission, yet the friction material 10 typically must not collapse.

In still other embodiments, the friction material 10 has a compression of from 2 to 30, from 6 to 20, or from 10 to 16, percent, at 2 MPa. Compression is a material property of the friction material 10 that may be measured when the friction material 10 is disposed on the substrate 32 (i.e., measured when part of a friction plate 30, described below) or when the friction material 10 is not disposed on the substrate 32. Typically, compression is a measurement of a distance (e.g. mm) that the friction material 10 is compressed under a certain load. For example, a thickness of the friction material 10 before a load is applied is measured. Then, the load is applied to the friction material 10. After the load is applied for a designated period of time, the new thickness of the friction material 10 is measured. Notably, this new thickness of the friction material 10 is measured as the friction material 10 is still under the load. The compression is typically related to elasticity, as would be understood by those of skill in the art. The more elastic the friction material 10 is, the more return that will be observed after compression. This typically leads to less lining loss and formation of less hot spots, both of which are desirable. In additional non-limiting embodiments, all values and ranges of compression values within and including the aforementioned range endpoints are hereby expressly contemplated.

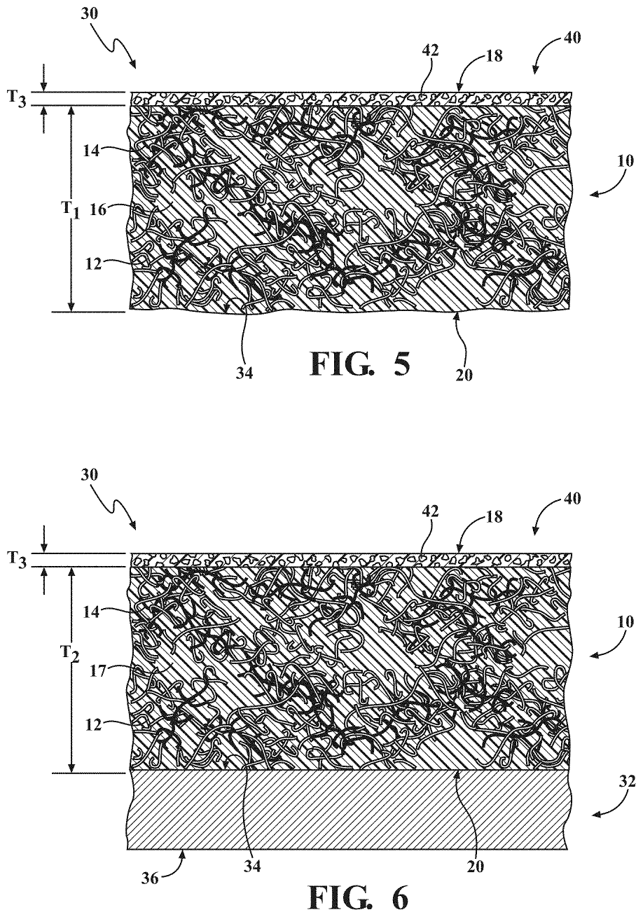

In some alternative embodiments, and with reference to FIG. 5, the friction material 10 may also include a “deposit” which is shown at 40. In some embodiments, the deposit 40 is disposed on the friction-generating surface 18 of the friction material 10 and included in the friction material 10 as a distinct and well-defined layer or deposit 40. Of course, in embodiments where a deposit 40 is utilized, the deposit 40 at least partially covers the friction-generating surface 18 and forms a deposit surface to generate friction. In other embodiments, the deposit 40 may be on the friction material 10 and also penetrate into friction material 10 (towards the bonding surface 20) wherein a concentration of the deposit 40 is greatest at the friction- generating surface 18. In embodiments where a deposit 40 is utilized, the deposit 40 can be described as defining a new friction-generating surface 18 to replace the previous friction-generating surface 18 which was defined by the friction material 10. Notably, the friction material 10 of these embodiments, is just as described above.

For example, in some such embodiments, the friction material 10 includes the deposit 40 and the deposit 40 defines the new friction-generating surface 18. In this example, the friction material 10 includes the unbranched fiber 12 (e.g. having a diameter of from 0.5 to 50 μm and a length of from 0.2 to 15 mm), the branched fiber 14 (e.g. having a diameter of from 1 to about 50 μm), and the resin 16. Of course, the friction material 10 of this embodiment defines a plurality of pores, e.g. having a pore size distribution with a D10 value of from 5 to 15 μm, a D50 value of from 15 to 30 μm, and a D90 value of from 30 to 60 μm.

In such embodiments, the deposit 40 has a thickness T₃ of from 10 μm to 600 μm, from 12 μm to 450 μm, from 12 μm to 300 μm, from 12 μm to 150 μm, or from 14 μm to 100 μm. Alternatively, the thickness T₃ of the deposit 40 is less than 150 μm, less than 125 μm, less than 100 μm, or less than 75 μm, but greater than 10 μm. In additional non-limiting embodiments, all values and ranges of values of thickness T₃ within and including the aforementioned range endpoints are hereby expressly contemplated. The thickness T₃ may refer to a thickness of the deposit 40 prior to, or after, resin 16 cure.

The deposit 40 includes friction-adjusting particles 42. In some embodiments, the deposit 40 includes friction-adjusting fibers such as the unbranched and branched fibers 12, 14 described above.

The friction-adjusting particles 42 may include one or more different types of particles. The friction-adjusting particles 42 provide a high coefficient of friction to the friction material 10. The type or types of the friction-adjusting particles 42 utilized may vary depending on the friction characteristics sought.

In various embodiments, the friction-adjusting particles 42 are chosen from diatomaceous earth particles, silica particles, carbon particles, graphite particles, alumina particles, magnesia particles, calcium oxide particles, titania particles, ceria particles, zirconia particles, cordierite particles, mullite particles, sillimanite particles, spodumene particles, petalite particles, zircon particles, silicon carbide particles, titanium carbide particles, boron carbide particles, hafnium carbide particles, silicon nitride particles, titanium nitride particles, titanium boride particles, cashew nut particles, rubber particles, and combinations thereof. In some embodiments, the friction-adjusting particles 42 are selected from carbon particles, diatomaceous earth particles, cashew nut particles, and combinations thereof.

In some embodiments, the friction-adjusting particles 42 include diatomaceous earth particles. Of course, in other embodiments, the friction-adjusting particles 42 consist essentially of or consist of diatomaceous earth particles. Of course, in some such embodiments, the friction material 10 consists essentially of or consists of diatomaceous earth particles. Diatomaceous earth is a mineral comprising silica. Diatomaceous earth is an inexpensive, abrasive material that exhibits a relatively high coefficient of friction. CELITE® and CELATOM® are two trade names of diatomaceous earth that may be used.

In various embodiments, the friction-adjusting particles 42 have an average diameter of from 100 nm to 80 μm, from 500 nm to 30 μm, or from 800 nm to 20 μm. In additional non-limiting embodiments, all values and ranges of values of average diameter within and including the aforementioned range endpoints are hereby expressly contemplated.

In various embodiments, the components of the deposit 40 (e.g. the friction-adjusting particles 42, friction-adjusting fibers, and/or any additives) are utilized in an amount of from 0.5 to 100 lbs. per 3000 ft² (0.2 to 45.4 kg per 278.71 m²) of a surface of the friction material 10, from 3 to 80 lbs. per 3000 f^{t2} (1.4 kg to 36.3 kg per 278.71 m²) of the surface of the friction material 10, from 3 to 60 lbs. per 3000 f^{t2} (1.4 kg to 27.2 kg per 278.71 m²) of the surface of the friction material 10, from 3 to 40 lbs. per 3000 f^{t2} (1.4 kg to 18.1 kg per 278.71 m²) of the surface of the friction material 10, from 3 to 20 lbs. per 3000 f^{t2} (1.4 kg to 9.1 kg per 278.71 m²) of the surface of the friction material 10, from 3 to 12 lbs. per 3000 f^{t2} (1.4 kg to 5.4 kg per 278.71 m²) of the surface of the friction material 10, or from 3 to 9 lbs. per 3000 f^{t2} (1.4 kg to 4.1 kg per 278.71 m²) of the surface of the friction material 10. In additional non-limiting embodiments, all values and ranges of values of amounts within and including the aforementioned range endpoints are hereby expressly contemplated. The amounts described immediately above are in units of lbs. per 3000 ft², which are units customarily used in the paper making industry as a measurement of weight based on a surface area. Above, the units express the weight of the deposit 40 for every 3000 ft² of the surface of the friction material 10.

In various embodiments, the friction material 10 is bonded to the substrate 32, which is typically metal. Several examples of the substrate 32 include, but are not limited to, a clutch plate, a synchronizer ring, and a transmission band. The friction material 10 includes the friction-generating surface 18 and an oppositely facing bonding surface 20. The friction-generating surface 18 experiences select interfacial frictional engagement with the opposed, rotating surface in the presence of a lubricant.

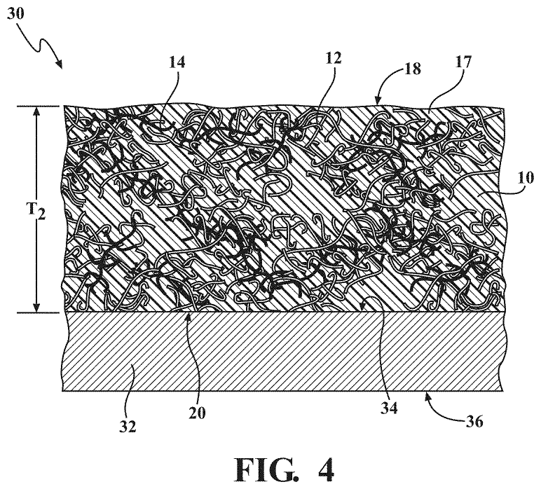

As shown in FIGS. 4 and 6, this disclosure also provides a friction plate 30 that includes the friction material 10 and the substrate 32 (e.g. a metal plate), as first introduced above. The substrate 32 has at least two surfaces 34, 36, and the friction material 10 is typically bonded to one or both of these surfaces 34, 36. The bonding or adherence of the friction material 10 to one or both surfaces 34, 36 may be achieved by any adhesive or means known in the art, e.g. a phenolic resin or any resin 16, 17 described above.

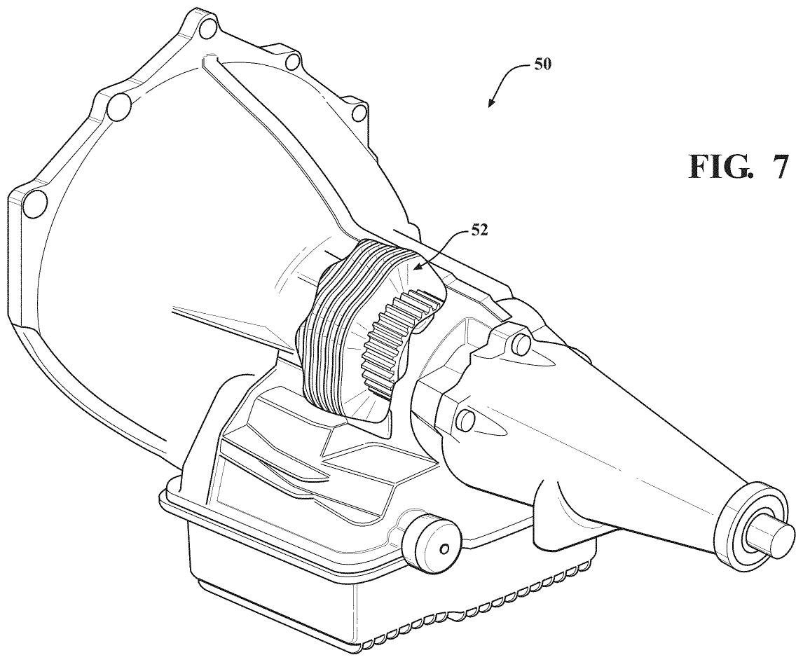

Referring now to FIG. 7, the friction plate 30 may be used, sold, or provided with a separator plate to form a clutch pack or clutch assembly 52. The clutch assembly 52 may be a “wet” clutch assembly or a “wet” clutch, which functions in the presence of fluid. This disclosure also provides the friction plate 30 itself including the friction material 10 and the substrate 32 and the clutch assembly 52 including the friction plate 30 and the separator plate.

Still referring to FIG. 7, the clutch assembly 52 of this disclosure can be included in a transmission 50. The transmission 50 may be an automatic transmission or a manual transmission.

All combinations of the aforementioned embodiments throughout the entire disclosure are hereby expressly contemplated in one or more non-limiting embodiments even if such a disclosure is not described verbatim in a single paragraph or section above. In other words, an expressly contemplated embodiment may include any one or more elements described above selected and combined from any portion of the disclosure. The following examples are intended to illustrate the present invention and are not to be viewed in any way as limiting to the scope of the present invention.

### EXAMPLES

Four examples of friction materials including unbranched fiber, branched fiber, and cured resin while being free of particles and representative of this disclosure (Examples 1-4) were formed. Comparative Example 1, a conventional friction material including fibers and particles, was also formed. After formation, Examples 1-4 and Comparative Example 1 were evaluated to determine various performance properties.

To make Examples 1-4, unbranched and branched fibers were blended to form a mixture. A porous, particle free, Fibrous Substrate Material was then formed with the mixture. The Fibrous Substrate Material was then impregnated with a resin. The Fibrous Substrate Material was impregnated with the resin and then heated to cure the resin and form the friction material of Examples 1-4. More specifically, the Fibrous Substrate Material impregnated with the resin and the mixture was precured in an oven for a time of about 30 min. at about 177° C. Then, the friction material was bonded to the core plate in an oven for a time of about 30 s. at about 210° C.

The compositions of Examples 1-4 are set forth below in Table 1.

TABLE 1

| Friction | | | | | |
|---|---|---|---|---|---|
| Material | Components | Example 1 | Example 2 | Example 3 | Example 4 |
| Fibrous | Unbranched | 90 vol. % | 85 vol. % | 35 vol. % | 30 vol. % |
| Substrate | Fibers | | | | |
| Material | Branched | 10 vol. % | 15 vol. % | 65 vol. % | 70 vol. % |
| | Fibers A | | | | |

| | | | | |
|---|---|---|---|---|
| Phenolic Resin | 55 wt. % | 55 wt. % | 55 wt. % | 55 wt. % |

The components in the Fibrous Substrate Material are set forth in volume percent based on a total volume of the Fibrous Substrate Material.

The amount of phenolic resin utilized is referred to as the “resin pick up.” That is, the amount of resin set forth in Table 1 is a weight percent based on a total weight of the Fibrous Substrate Material.

Unbranched fibers are aramid fibers having an average diameter of 12 μm and an average length of 1.5 mm.

Branched fibers A are aramid fibers having a CSF value of from 300 to 680 mL.

Phenolic Resin is a standard phenolic resin.

The Fibrous Substrate Material Examples 1-4 were tested. The test results are set forth Table 2 below.

TABLE 2

| | Example 1 | Example 2 | Example 3 | Example 4 |
|---|---|---|---|---|
| Basis Weight | 183 | 178 | 84 | 86 |
| (lbs./3000 ft²) | | | | |
| Processability of the | Poor | Poor | Okay | Good |
| Fibrous Substrate | | | | |
| Wet Tensile ASTM | 1200 g/in | 960 g/in | 1750 g/in | 2434 g/in |
| D829-97 | | | | |

Wet tensile was tested in accordance with ASTM D829-97, 1 inch wide by 10-inch-long samples of friction material, saturated with alcohol, are pulled at a rate of 1 in/min.

With references to Tables 1 and 2 above, volume ratios of 35:65 and 30:70, unbranched fibers to branched fibers, unexpectedly demonstrate excellent: (1) basis weight (which positively effect part weight and cost); (2) processability; and (3) wet tensile strength.

Four additional examples of friction materials including unbranched fiber, branched fiber, and cured resin while being free of particles and representative of this disclosure (Examples 5-8) are formed. To make Examples 5-8, various fiber types are blended to form a mixture. A porous, particle free, Fibrous Substrate Material was then formed with the mixture. The Fibrous Substrate Material was then impregnated with a resin. The Fibrous Substrate Material was impregnated with the resin and then heated to cure the resin and form the friction material of Examples 5-8. More specifically, the Fibrous Substrate Material impregnated with the resin and the mixture was precured in an oven for a time of about 30 min. at about 177° C. Then, the friction material was bonded to the core plate in an oven for a time of about 30 s. at about 210° C.

The compositions of Examples 5-8 are set forth below in Table 3.

TABLE 3

| Friction | | | Exam- | Exam- | Exam- |
|---|---|---|---|---|---|
| Material | Components | Example 5 | ple 6 | ple 7 | ple 8 |
| Fibrous | Unbranched | 30 vol. % | 30 | 30 | 30 |
| Substrate | Fibers | | vol. % | vol. % | vol. % |
| Material | Branched | 70 vol. % | 70 | 70 | 35 |
| | Fibers A | | vol. % | vol. % | vol. % |
| | Branched | — | — | — | 35 |
| | Fibers B | | | | vol. % |

| | | | | |
|---|---|---|---|---|
| Phenolic Resin | 90 wt. % | 75 | 55 | 55 |
| | | wt. % | wt. % | t. % |

Branched fibers B are cellulose fibers having CSF value of 690 mL.

For convenience, the amount of resin included in each of the Examples and Comparative Examples is noted as the Resin Pick Up (“RPU”), which is simply the resin content disclosed in Tables 1 and 2 above.

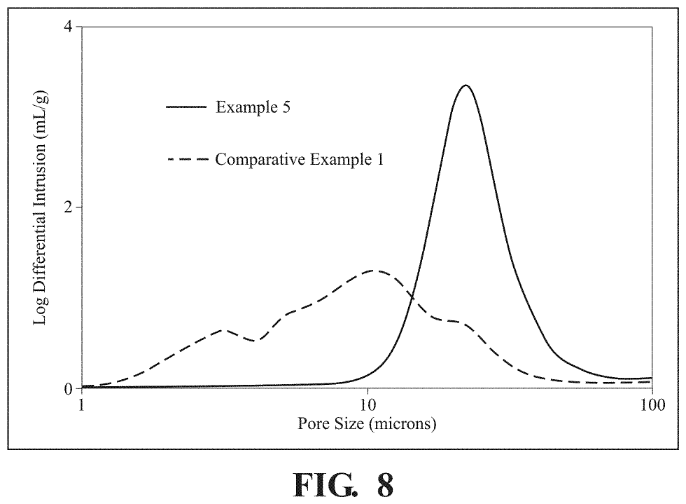

Once made, Example 5-8 and Comparative Example 1 were tested to determine various performance properties. The test results are set forth in FIGS. 8-11.

Referring now to FIG. 8, Example 5 and Comparative Example 1 were tested for pore size and pore size distribution in accordance with American Society for Testing and Materials (“ASTM”) test method D4404-10. As is illustrated, Example 5 has a plurality of pores that are larger and more consistent than the pores of Comparative Example 1. More specifically, Example 5 has a D10 value about 13, μm; a D50 value of about 23, μm; and a D90 value of about 46, μm. In contrast, Comparative Example 1 has a D10 value about 3, μm; a D50 value of about 9, μm; and a D90 value of about 28, μm.

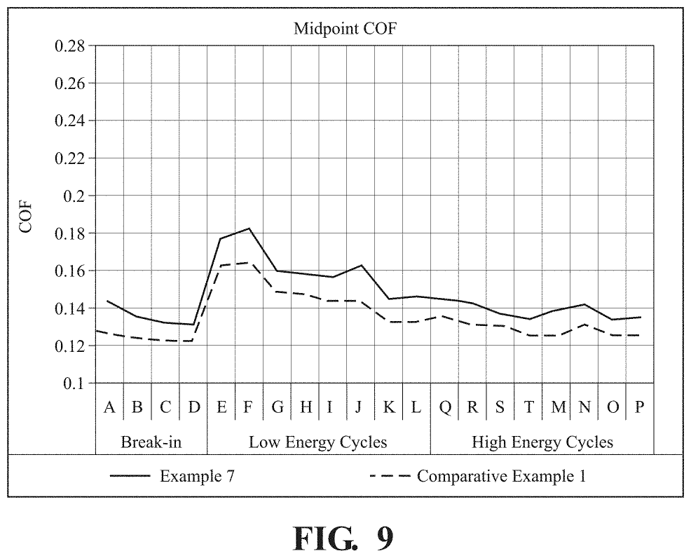

Referring now to FIG. 9, the coefficient of friction (“COF”) of the friction materials of Example 7 and Comparative Example 1 was tested on a SAE no. 2 machine. Four double-sided friction plates and transmission fluid was used to simulate the operating environment of shifting clutch condition. In FIG. 8, the friction material of Example 7, which is free of particles, surprisingly demonstrates higher COF over Comparative Example 1, which includes particles.

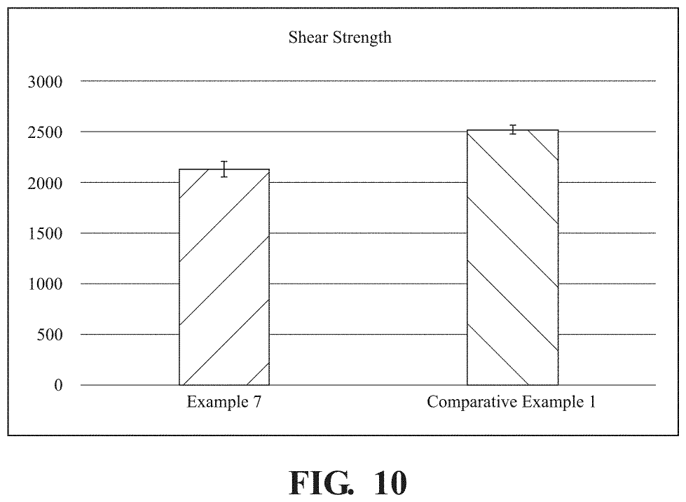

Referring now to FIG. 10, Example 7 and Comparative Example 1 were tested for “shear strength”. Surprisingly, the friction material of Example 7, which is free of particles, exhibits a similar shear strength to Comparative Example 1, which includes particles.

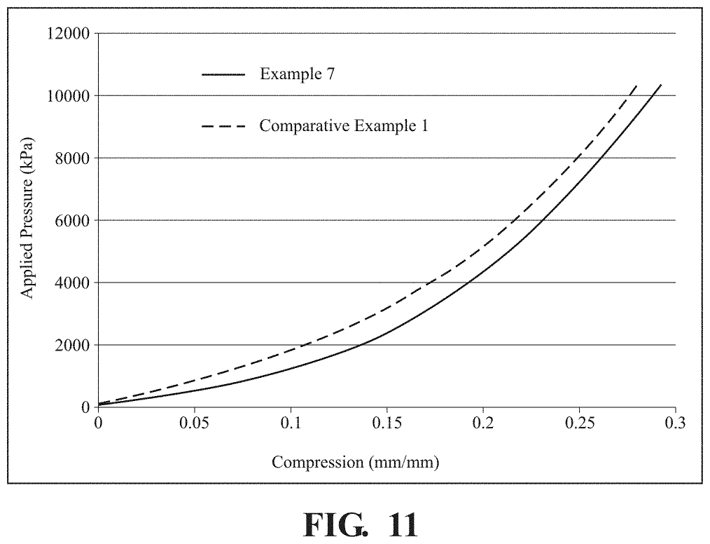

Referring now to FIG. 11, Example 7 and Comparative Example 1 were tested for “compression”. In FIG. 11, the compression of Example 7 under 2 MPa is about 13%. Surprisingly, the friction material of Example 7, which is free of particles, exhibits a similar compression to Comparative Example 1, which includes particles.

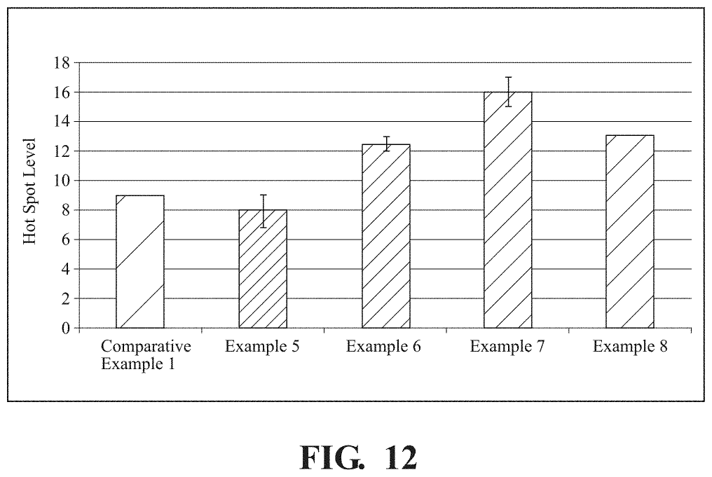

The coefficient of friction (“COF”) of the friction materials of Examples 5-8 were tested on a SAE no. 2 machine. Referring now to FIG. 12, the “Hot Spot Level” is set forth, with a resin loading of 55% providing excellent hot spot performance. Generally speaking, the hot spot performance of Examples 5-8 was indicative of good friction properties and excellent cooling due to the pore structure of Examples 5-8.

One or more of the values described above may vary by ±5%, ±10%, ±15%, ±20%, ±25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

It is also to be understood that any ranges and subranges relied upon in describing various embodiments of the present disclosure independently and collectively fall within the scope of the appended claims and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e. from 0.1 to 0.3, a middle third, i.e. from 0.4 to 0.6, and an upper third, i.e. from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

1. A friction material presenting a friction-generating surface and a bonding surface opposite said friction-generating surface, said friction material comprising:
unbranched fiber having a diameter of from 0.5 to 50 μm and a length of from 0.2 to 15 mm;
branched fiber having a diameter of from 1 to 50 μm; and
a resin disposed throughout said friction material;
wherein said friction material is substantially free of particles; and
wherein said friction material defines a plurality of pores having a pore size distribution with a D10 value of from 5 to 15 μm, a D50 value of from 15 to 30 μm, and a D90 value of from 30 to 60 μm.

2. The friction material as set forth in claim 1 wherein said plurality of pores has a pore size distribution with a D10 value of from 7 to 13 μm, a D50 value of from 15 to 23 μm, and a D90 value of from 34 to 46 μm.

3. The friction material as set forth in claim 1 wherein said unbranched fiber is chosen from acrylic fibers, aramid fibers, carbon fibers, cellulose fibers, glass fibers, mineral fibers, phenolic fibers, polyvinyl alcohol fibers, and combinations thereof.

4. The friction material as set forth in claim 1 wherein said unbranched fiber comprises aramid fibers and/or carbon fibers.

5. The friction material as set forth in claim 1 wherein said branched fiber is chosen from acrylic fibers, aramid fibers, cellulose fibers, and combinations thereof.

6. The friction material as set forth in claim 1 wherein said branched fiber comprises aramid fibers and/or cellulose fibers.

7. The friction material as set forth in claim 1 wherein said branched fiber has a Canadian Standard Freeness (CSF) degree of fibrillation of from 10 to 700.

8. The friction material as set forth in claim 1 wherein:
said unbranched fiber has a diameter of from 1 to 25 μm and a length of from 0.5 to 10 mm; and
said branched fiber has a diameter of from 2 to 20 μm.

9. The friction material as set forth in claim 1 wherein said unbranched fiber and said branched fiber are present in said friction material in a volume ratio of from 1:5 to 1:1.

10. The friction material as set forth in claim 1 wherein said unbranched fiber and said branched fiber are collectively present in said friction material in an amount greater than 90 weight percent, based on a total weight of all non-resin components in said friction material.

11. The friction material as set forth in claim 1 wherein said resin is present in said friction material in an amount of from 45 to 120 weight percent based on a total weight of all non-resin components in said friction material.

12. The friction material as set forth in claim 1 wherein said friction material has a porosity of from 50% to 85% as determined using ASTM D4404-10.

13. The friction material as set forth in claim 1 that is free of particles.

14. A friction plate comprising a substrate and said friction material as set forth in claim 1, which is cured and bonded to said substrate.

15. A wet clutch assembly comprising said friction plate of claim 14 and a separator plate.

16. A transmission comprising said wet clutch assembly of claim 15.

17. A friction material defining a plurality of pores and presenting a friction-generating surface and a bonding surface opposite said friction-generating surface, said friction material comprising:
unbranched fiber having a diameter of from 0.5 to 50 μm and a length of from 0.2 to 15 mm:
branched fiber having a diameter of from 1 to 50 μm; and
a resin disposed throughout said friction material;
wherein said unbranched fiber and said branched fiber are present in said friction material in volume ratio of from 1:5 to 1:1, and are collectively present in said friction material in an amount greater than 90 weight percent, based on a total weight of all non-resin components in said friction material.

18. The friction material as set forth in claim 17 wherein said resin is present in said friction material in an amount of from 45 to 120 weight percent based on a total weight of all non-resin components in said friction material.

19. The friction material as set forth in claim 17 wherein said plurality of pores has a pore size distribution with a D10 value of from 5 to 15 μm, a D50 value of from 15 to 30 μm, and a D90 value of from 30 to 60 μm.

20. A friction material presenting a friction-generating surface and a bonding surface opposite said friction-generating surface, said friction material comprising:
unbranched fiber having a diameter of from 0.5 to 50 μm and a length of from 0.2 to 15 mm;
branched fiber having a diameter of from 1 to 50 μm; and
a resin disposed throughout said friction material;
wherein said friction material defines a plurality of pores having a pore size distribution with a D10 value of from 5 to 15 μm, a D50 value of from 15 to 30 μm, and a D90 value of from 30 to 60 μm; and
a deposit on said friction-generating surface of said friction material, said deposit comprising friction-adjusting particles.

21. The friction material as set forth in claim 20 wherein said branched fiber has a Canadian Standard Freeness (CSF) degree of fibrillation of from 10 to 700.

22. The friction material as set forth in claim 20 wherein said unbranched fiber and said branched fiber are collectively present in said friction material in an amount greater than 90 weight percent, based on a total weight of all non-resin components in said friction material.

23. The friction material as set forth in claim 20 wherein said unbranched fiber and said branched fiber are present in said friction material in a volume ratio of from 1:3 to 2:3.

24. The friction material as set forth in claim 20 wherein said resin is present in an amount of from 45 to 120 weight percent based on a total weight of all non-resin components in said friction material.
